(19) United States
(12) Patent Application Publication
(10) Pub. No.: US 2021/0372608 A1
(43) Pub. Date: Dec. 2, 2021

(54) CANDLE DECK CAKE PROTECTOR

(71) Applicant: Kassem Bazzi, Deerborn, MI (US)

(72) Inventor: Kassem Bazzi, Deerborn, MI (US)

(21) Appl. No.: 16/886,818

(22) Filed: May 29, 2020

(51) Int. Cl. F21V 35/00

(52) U.S. Cl. CPC F21V 35/006; F21W 2121/002; A47G 2400/061

(57) ABSTRACT

A sanitary candle deck for cakes and method for presenting ceremonious cakes. The deck has a series of apertures into which each individual candle by friction-force. The base of the candles are inserted into the cake in standard custom. Upper ends of each candle extend above the deck surface for lighting each respective wick in ceremony. The deck protects the cake by collecting hot melting wax and potential saliva-born germs from blowing candles.

### CROSS-REFERENCFS TO RELATED APPLICATIONS

(Not Applicable)

### STATEMENT REGARDING FEDERALLY SPONSORED RESEARCH AND DEVELOPMENT

(Not Applicable)

### REFERENCE TO AN APPENDIX

(Not Applicable)

### BACKGROUND OF THE INVENTION

### 1. Field of The Invention

Generally, the invention relates to the field of covers for cakes. Particularly, the invention relates to protectors for ceremonious cakes such as birthday cakes. Specifically, the inventions relates to an improved cake protector that holds candles and is supported by candles.

### 2. Background of the Invention

Kitchenware such as plastic cake server caddies and Bundt cake keepers are well-known for storing and transporting cakes and bakery goods. These types of devices contain a dome or cover for covering and protecting the cake surfaces and a flat base to facilitate carrying and supporting a cake.

U.S. Pat. No. 10,463,180 B1 discloses a candle deck and cake cover. The cover has a base serving as a platter and a removable candle deck that is stored in an upper recess of the cake cover. The candle deck interlocks onto an upper receiving lip of the cover. The deck receives candles securely for lighting in celebration.

U.S. D584,926 S claims a design for an ornamental combined cake protector and candle holder. The protector covers the cake and secures lighted candles in a recessed area of the protector surface. U.S. Pat. No. D737,106 S is a design patent for a candle-receiving sheet cake cover. The cover has with a series of apertures formed to receive candles.

U.S. Pat. No. 5,096,274 discloses a disposable celluloid transparent cake cover that also has a plurality of depressions formed on the surface of the cover. The depressions hold and support standard small longitudinal candles and there are depressions for accepting and holding the base of larger numeral candles. The cover is formed with decorative features.

U.S. Pat. No. 10,463,481 B2 also discloses a disposable cake protector with a surface area of the protector receives candles. A series of decorative legs support the protector over the cake.

These inventions and other similar prior art inventions all solve the issue of protecting the cake from the saliva of the person blowing out the candles and protecting the cake from the melted wax. Additionally, these inventions provide for transport and display of the cake and permit the display of the cake with burning candles. However, the prior art inventions require the cake to be made of a predetermined size and shape, but more importantly, do not permit the candles to be into contact with the cake. The result is a lack of authenticity of the practice, because the custom is to insert the candle into the cake itself. The present invention provides for a candle-accepting cake cover that solves all the issues and accomplishes the customary practice.

### BRIEF SUMMARY OF THE INVENTION

It is a general object of this invention to provide a cake cover.

It is an object of this invention to provide a cake cover that will not detract from the decorative appearance of a celebrational cake.

Another object of the invention is to provide a cake cover that protects the cake from melted hot wax and germs from the saliva sprayed by a person blowing out the candles.

One further object is to provide a cake cover that works with the customary practice of inserting the candles into the cake surface but protecting the cake from chemicals of hot wax and germs.

In accomplishment of these objects, a unitary planar structure is provided. The structure is mounted over the cake surface and supported by the candles. The structure friction fits onto the candles preferably substantially midpoint along the longitudinal column of the candle, resulting in the structure suspended above the cake. The device can be of circular or rectangular shape, depending on the shape of the cake being covered. The cover should be constructed of a lightweight transparent material to allow viewing of the cake.

### BRIEF DESCRIPTION OF THE SEVERAL VIEWS OF 1HE DRAWINGS

FIG. 1 is a side view in perspective of a circular embodiment of the invention.

FIG. 2 is a side view in perspective of the circular embodiment of the invention in combination with a celebratory cake.

In conclusion, the present invention in using the aforementioned structure has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein.

### DETAILED DESCRIPTION OF THE INVENTION

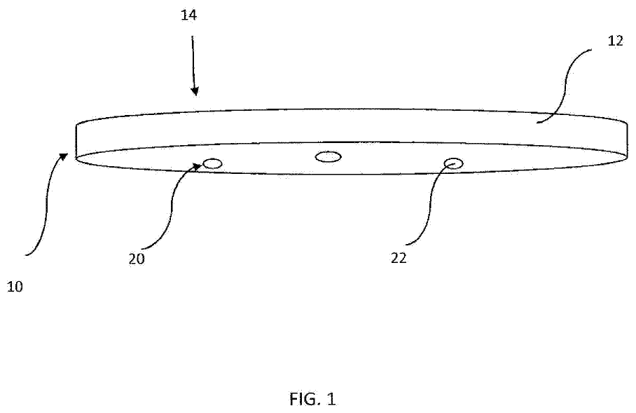

FIG. 1 shows an improved sanitary cake surface protector 10. The protector 10 has a substantially planar protective deck 14. Each of a plurality of apertures 20 extends through the deck 14. Each aperture 20 has a respective aperture wall 22.

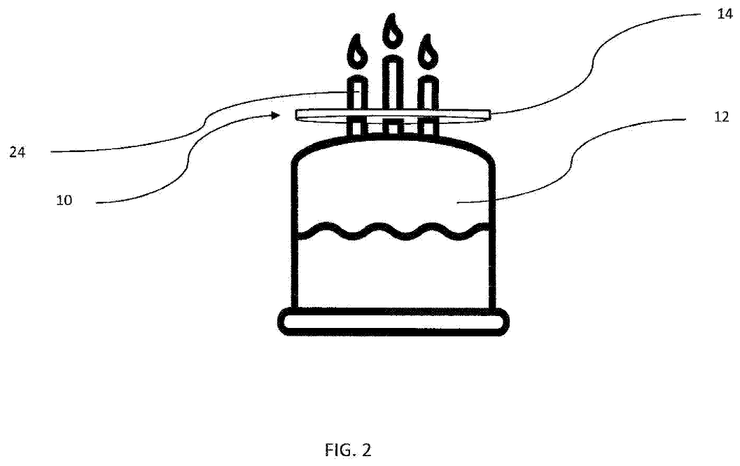

FIG. 2 shows the improved sanitary cake surface protector 10 in combination with a cake 12. A preparer orients the deck 14 substantially parallel to the cake 12 then inserting the and inserting each lower region of the candle 24 into the cake 12 suspends the deck 14 above the cake 12.

This presentation is preferred for a cake 12 having three or more candies 24 thereon, so that the cake 12 can be presented in customary fashion with candles 24 inserted into the cake 12. The preparer inserts each of said respective candles 24 through a respective aperture 20 until the candle 24 is held secure by friction force with each respective aperture walls 22.

The candles 24 are held secured in each of said apertures 20 at a point where a about half of said candle 24 length remains above said candle deck 14. The candle 12 has a diameter at least as wide as the apertures 20 at the point of contact with the walls 22. This allows the deck to be removably positioned suspended above said cake 12. The melting hot wax drippings are captured on the deck 14. The cake 12 is protected from the chemicals in the drippings, as well as any germs that would be in saliva from a person blowing out the candles 24 (not illustrated).

The cover 10 is formed of a substantially rigid transparent material such as celluloid or thin polymer and may be washable or disposable. Other embodiments of the invention can be different shapes or lightly hued.

While certain preferred embodiments of the present invention have been disclosed in detail, it is to be understood that, various modifications may be adopted without departing from the spirit of the invention or scope of the following claims.

I claim:

1. In combination, an improved sanitary cake surface protector to be used with varying sized ceremonious cakes comprising:
a substantially planar protective candle deck for, and in combination with, a cake, said candle deck comprising an upper surface and a lower surface with a plurality of apertures extending through said deck between said upper surface and said lower surface, and each aperture having a respective aperture wall;
Wherein said candle deck is removably positioned on said cake by a plurality of candles, each of said candles being respectively inserted into a respective aperture into friction-force contact with said walls of each of said apertures.

2. An improved method of presenting a cake having three or more candles thereon comprising the steps of:
Providing a cake;
Providing a substantially planar protective candle deck for, and in combination with, a cake, said candle deck comprising an upper surface and a lower surface with a plurality of apertures extending through said deck between said upper surface and said lower surface, and each aperture having a respective aperture wall;
Inserting each of said respective candles through a respective aperture into friction-fit with said walls of each of said apertures at a point where at least 2 inches of said candle length remains above said upper surface of said candle deck;
removably positioning said deck on said cake by inserting a base of said candle into said cake surface to result in said deck suspended above said cake.
